(19) United States
(12) Patent Application Publication
(10) Pub. No.: US 2026/0187591 A1
(43) Pub. Date: Jul. 2, 2026

(54) EFFICIENT LEVERAGE OF GENERATIVE OUTPUT-BASED FEATURES OF A COLLABORATION PLATFORM

(71) Applicant: Atlassian Pty Ltd., Sydney (AU)

(72) Inventors: Thirumalaivelu Alagianambi, Milpitas, CA (US); Rudra Saha, Jersey City, NJ (US); Guillaume Ménard, San Jose, CA (US); Kasirajan Selladurai Selvakumari, Sunnyvale, CA (US)

(21) Appl. No.: 19/002,681

(22) Filed: Dec. 26, 2024

(51) Int. Cl. G06Q 10/101; G06F 40/12; G06Q 10/10

(52) U.S. Cl. CPC G06Q 10/101; G06F 40/12; G06Q 10/103

(57) ABSTRACT

Systems and methods for condensing structured data representing declarative graphical objects prior to providing those structured data as input to generative output systems to perform generative output functions with fewer input tokens.

### TECHNICAL FIELD

Embodiments described herein relate to collaboration systems configured to receive and serve user-generated content and, in particular, to systems and methods for efficiently providing declarative graphical content as input to a generative output feature of a user-generated content system.

### BACKGROUND

An organization can establish a collaborative work environment by self-hosting, or providing its employees with access to, a suite of discrete software platforms or services to facilitate cooperation and completion of work. Among common software platform types, an increasing number of organizations leverage one or more private generative artificial intelligence (“AI”) systems to assist employees or customers with tasks.

However, such AI systems require significant computational power. Further, different requests for AI assistance can result in different required computational effort and therefore different latency, leading to a perception of inconsistent system responsiveness. Further, certain request types can result in significant expense for the organization if performed repeatedly or if such requests include a high number of input tokens.

### BRIEF DESCRIPTION OF THE DRAWINGS

Reference will now be made to representative embodiments illustrated in the accompanying figures. It should be understood that the following descriptions are not intended to limit this disclosure to one included embodiment. To the contrary, the disclosure provided herein is intended to cover alternatives, modifications, and equivalents as may be included within the spirit and scope of the described embodiments, and as defined by the appended claims.

FIG. 1 depicts a system diagram of a collaboration system as described herein.

FIGS. 2A-2B depict a client device of a collaboration system as described herein rendering, within a frontend graphical user interface, affordances and modal windows associated with functionality that leverages generative output to engage with one or more objects of a cluster of objects of free-form graphical content of the collaboration system.

FIG. 2C depicts the client device of FIGS. 2A-2B rendering affordances and modal windows associated with functionality that leverages generative output to engage with a large cluster of objects of free-form graphical content of the collaboration system.

FIG. 3 depicts a system diagram of a prompt management system as described herein.

FIG. 4 depicts a flowchart of operations corresponding to a method of token reduction for declarative graphic objects prior to being provided as serialized text input to a generative output engine, as described herein.

The use of the same or similar reference numerals in different figures indicates similar, related, or identical items.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Embodiments described herein relate to systems and methods for ensuring that use of generative artificial intelligence (“AI”) systems within a collaboration environment is consistent across multiple input types (e.g., graphical input, text input), in terms of request latency, user experience, and cost of computation.

In particular, systems described herein relate to systems and methods for condensing verbose structured data formats describing free-form and unconstrained graphical user input provided by one or more users of a collaboration system (e.g., drawings, diagramming, flowcharting, collage note-taking, and the like) into concise structured data formats. The concise structured data format can be provided as input to an AI system as a prompt or an attachment to a prompt. In this manner, graphical user-generated content (or, more precisely, structured data describing graphical content) can be provided as input to an AI system without the large token count associated with verbose structured data formats.

For example, a simple rectangle drawn by a user may be described and/or stored in a collaboration system environment by a JavaScript Notation object (JSON) that verbosely captures the style, position, and size of that rectangle. The verbose description can further include border information, margin information, padding information, and/or metadata relevant to the rectangle. An example verbose JSON object follows:

```
{
  “rectangle”: {
    “geometry”: {
      “origin”: {
        “x”: 0.0,
        “y”: 0.0
      },
      “width”: 10.0,
      “height”: 5.0,
      “rotation”: {
        “angle”: 0.0,
        “unit”: “degrees”
      }
    },
    “vertices”: [
      {
        “x”: 0.0,
        “y”: 0.0
      },
      {
        “x”: 10.0,
        “y”: 0.0
      },
      {
        “x”: 10.0,
        “y”: 5.0
      },
      {
        “x”: 0.0,
        “y”: 5.0
      }
    ],
    “boundingBox”: {
      “topLeft”: {
        “x”: 0.0,
        “y”: 5.0
      },
      “bottomRight”: {
        “x”: 10.0,
        “y”: 0.0
      }
    }
  },
  “style”: {
    “lineColor”: {
      “r”: 0,
      “g”: 0,
      “b”: 0,
      “a”: 1.0
    },
    “fillColor”: {
      “r”: 255,
      “g”: 255,
      “b”: 255,
      “a”: 1.0
    },
    “lineThickness”: 1.0,
    “lineStyle”: “solid”
  },
  “coordinateSystem”: {
    “scale”: {
      “x”: 1.0,
      “y”: 1.0
    },
    “units”: “pixels”,
    “axisLabels”: {
      “x”: “X-axis”,
      “y”: “Y-axis”
    },
    “grid”: {
      “enabled”: true,
      “spacing”: {
        “x”: 1.0,
        “y”: 1.0
      },
      “lineStyle”: “dashed”,
      “lineColor”: {
        “r”: 0,
        “g”: 0,
        “b”: 255,
        “a”: 0.5
      }
    }
  },
  “metadata”: {
    “description”: “”,
    “createdBy”: “User”,
    “creationDate”: “2022-11-04T12:00:00Z”,
    “editable”: true
  }
}
```

Although the preceding JSON object defines the example rectangle comprehensively, providing the object as input to a generative output engine or a general purpose AI system may be associated with high computational cost and/or unexpected output as a majority of the attributes are either blank, zero, or null and therefore do not affirmatively contribute to rendering of the rectangle itself. More simply, the rectangle may be more concisely described without losing information about the resulting shape. As one example, a diagram scripting language (such as D2Lang) representation of the same rectangle, with the same dimensions, may be described with the following object:

```
rectangle: “” {
  shape: rectangle
  width: 10
  height: 5
}
```

Providing the second object as serialized text input to a generative output engine results in significantly fewer tokens without information loss in respect of the rectangle itself. Embodiments described herein relate to systems and methods for translating, mapping, and/or converting verbose structured data formats into concise structured data formats as a preprocessing step. More broadly, input data conforming to a first format may be converted to conform with a second format. In this manner, free form graphical user input can be efficiently provided as input to a generative AI system for any suitable purpose. The operations associated with reformatting, translating, converting, or mapping verbose formats to concise formats may be referred to as “reduction” operations.

For example, a reduction operation can include mapping one attribute type to another attribute type, one field to another field, or the like. In some cases, a reduction operation can include or leverage a lookup table configured to identify redundant attributes or values, blank attributes or values, null attributes or values or the like. In other cases, a lookup table can be configured to merge one or more fields together, convert one data type to another data type, or the like. In some cases, a specialized feature of a first format can be converted to an equivalent feature of a second format. For example, in some cases an original format can include a product-specific feature, such as a stylized hyperlink, which may be converted to a text link, a snippet, a note, or a geometric shape of a second format. In some cases, different conversions of different objects to different object types can be selected for different reduction “depths.”

For example, free-form graphical user input such as a drawn sketch of an animal may be reduced to a concise format and provided as input to a generative AI system along with a prompt requesting a text summary of the drawn sketch.

In another example, a set of digital sticky notes added to a free-form whiteboarding application during a meeting by a number of users at different times can be reduced to a concise graph format and provided as input to a generative AI system along with a prompt requesting a text summary of the meeting during which the sticky notes were added. In other examples, the generative AI system can be requested to create work items, assign work items, send emails, create meeting notes documentation, combine multiple notes together, create new sticky notes in the same whiteboard application, or perform any other suitable operation or set of operations with the whiteboard application, a particular canvas or board of the whiteboard application, or with any other collaboration tool or platform associated therewith.

In some embodiments, a free-form graphical user interface system may be unbounded. These systems are sometimes referred to as “infinite canvas” input systems. In such examples, a system as described herein can be configured to automatically cluster individual objects or features of a large canvas prior to, or as a portion of, a reduction operation as described herein. For example, a single user may continually add information and/or graphical objects to a single canvas such that different regions of the canvas include information related to different topics (e.g., different brainstorming sessions, different meetings, different projects, and the like). In this example, a user may trigger or invoke a reduction operation by selecting a particular group of objects and requesting engagement of an AI system therewith. In other cases, a system as described herein can automatically cluster different objects based on nearest-neighbor groupings or other spatial relationship clustering, semantic clustering, hierarchical clustering, clustering based on physics engine processing (e.g., force-directed graph layouts), heatmap clustering, zoom or window viewport based clustering, and the like. Once a group of objects has been clustered or otherwise selected by the user or by operation of a system as described herein, the structured data objects or files representing or describing those objects within the cluster (or set, or other construct) can be reduced as described herein.

In this manner, broadly and without limitation, a system as described herein can be configured to group or cluster objects in a free-form graphical user interface application, reduce the structured data objects that verbosely describe the position, arrangement, style, size, interconnections, and other features of those objects to concise formats, and provide the concisely-formatted structured data objects as input along with an arbitrary prompt to a generative AI system. The arbitrary prompt may request the generative AI system to perform a function, such as summarizing the graphical input, performing a task based on the graphical input, restructure or reorganize the graphical user input, or any other suitable operation. For simplicity of description and illustration, many embodiments that follow reference an example in which a generative AI system is prompted to perform a generative output function such as an operation to summarize a graphical object or set of graphical objects, but it may be appreciated that this is merely one example; in a collaboration system context, a generative AI system can be prompted in a number of suitable ways.

In other cases, a generative AI system as described herein can be configured to operate against multimedia input. An example multimedia input may be a document of a documentation platform that contains or cross-links to embedded graphics. In other cases, an example multimedia input may be a kanban board that, when rendered, includes graphical cues for a user indicating status or relationships between different cards of the board. In other cases, a multimedia input can include a textually-defined animation. In this example, the animation itself may be reduced as described herein.

More broadly, a generative AI system—or more broadly, a content generation system—can be any system or system architecture configured for generating content, generating Application Programming Interface (API) requests and/or request bodies, structuring user-generated content, and/or generating structured content in collaboration platforms, such as documentation systems, issue tracking systems, project management platforms, and the like. In particular, the embodiments described herein support systems that can be used to provide content generation services across a suite of software platforms.

As an example, a content generation system can be configured to receive a document as input—which may include user-generated graphical elements embedded therein—and to perform any suitable generative output function in response. For example, a content generation system can be configured to provide generative output by providing a short summary of the content of the document, along with the graphic(s), as output. The summary may be rendered in a graphical user interface, inserted into a notification, or provided to a user in any suitable manner. In other cases, a content generation system as described herein can be configured to generate an image in response to a user's freeform prompt thereafter inserting the image into a body of a document.

These foregoing examples are not exhaustive; a person of skill in the art may appreciate that content generation systems as described herein can be configured to receive multimodal input and to provide multimodal output that may be useful to a user of one or more software platforms or collaboration tools. For simplicity of description, the embodiments that follow contemplate a content generation system configured to receive multimodal input (which may include text content, image content, structured data describing objects) and configured to provide text as output, but it may be appreciated that this is merely one example.

A content generation service as described herein may include a generative service that causes display of a generative interface panel within a graphical user interface of a content collaboration platform. The generative interface panel is able to provide automated responses and content generation actions in response to natural language prompts. The generative interface panel can also provide access to a set of agents that may be invoked expressly by the user or in response to an action intent determined using the user input (e.g., real-time typing analysis, user voice input, and so on).

The generative service operating the agents may also include a persistence module that leverages prior queries and exchanges—in respect of one user, a group of users, or an entire organization's knowledge base—in order to provide a more complete or accurate context in which a generative response can be provided. The generative service may also be able to access context data, extract content from a current user session or from a set of related user sessions (e.g., a group of users collaborating on a single document), and access cross-platform content in order to respond to a wide variety of natural language and/or multimedia input.

A person of skill in the art may appreciate that the foregoing example is merely one architecture. More specifically, a generative output from a content generation system as described herein can be triggered and/or interacted with in any number of suitable ways. A chatbot, an agent, and/or affordances in user interfaces are merely examples.

For example, broadly, automatically generated content regardless how that content was requested to be generated by a user (e.g., prompted), and regardless of the software system through which that request was received—can supplement, summarize, format, and/or structure existing tenant-owned user-generated content created by a user while operating a software platform, such as described herein.

As noted above, in one embodiment, user-generated content can be supplemented by an automatically generated summary. The generated summary may be prepended to the content such that when the content is rendered for other users, the summary appears first. In other cases, the summary may be appended to the end of the document. In yet other examples, a generated summary may be transmitted to another application, messaging system, or notification system. For example, a generated document summary can be attached to an email, a notification, a chat or helpdesk support message, or the like, in lieu of being attached or associated with the content it summarizes.

In another example, user-generated content can be supplemented by automatic insertion of format markers or style classes (e.g., markdown tags, style classes, and the like) into the user-generated content itself. In other examples, user-generated content can be rewritten and/or restructured to include more detail, remove unnecessary detail, and/or adopt a more neutral or positive tone. These examples are not exhaustive.

In yet other examples, multiple disparate user-generated content items, stored in different systems or in different locations, can be grouped or merged together into a single summary or list of summaries.

In addition to embodiments in which automatically generated content is generated in respect of existing user-generated content (and/or appended thereto), automatically generated content as described herein can also be used to supplement API requests and/or responses generated within a multiplatform collaboration environment.

For example, in some embodiments, API request bodies can be generated automatically leveraging systems described herein. The API request bodies can be appended to, and/or may replace, an API request provided as input to any suitable API of any suitable system. In many cases, an API with a generated body can include user-specific, API-specific, and/or tenant-specific authentication tokens that can be presented to the API for authentication and authorization purposes.

The request bodies, in these embodiments, can be structured so as to elicit particular responses from one or more software platforms' API endpoints. For example, a documentation platform may include an API endpoint that causes the documentation platform to create a new document, with particular graphical content, from a specified template. Specifically, in these examples, a request to this endpoint can be generated, in whole or in part, automatically. In other cases, an API request body can be modified or supplemented by automatically generated output, as described herein.

For example, an issue tracking system may present an API endpoint that causes creation of new issues in a particular project. In this example, string or other typically user provided typed data such as a new issue title, new issue state, new issue description, and/or new issue assignee fields can be automatically generated and inserted into appropriate fields of a JSON-formatted request body. Submitting the request, as modified/supplemented by automatically generated content, to the API endpoint can result in creation of an appropriate number of new issues. In these examples, a graphical representation of the new issue and/or a portion thereof (e.g., a flowchart of a proposed solution to the issue, or a flowchart corresponding to a method described in a support document linked in the issue request) may also be automatically generated and appended to the issue itself.

In another example, a trouble ticket system (e.g., an information technology service management or “ITSM” system) may include an interface for a service agent to chat with or exchange information with a customer experiencing a problem. In some cases, automatically generated content can be displayed to the customer, whereas in other cases, automatically generated content can be displayed to the service agent. In these examples, graphical content that might otherwise be screenshot by a service agent and inserted as an attachment into a chat window may be textually summarized. For example, a flowchart identified as a potential solution to a user issue by the service agent may be summarized as a textual set of steps that may be copied into the chat window by the agent or automatically by operation of systems described herein.

For example, in the first case, automatically generated content can summarize and/or link to one or more documents that outline troubleshooting steps for common problems. These documents may include one or more graphics such as flowcharts or system diagrams that may assist the agent in identifying or classifying the user issue or, in other cases, may assist the user in troubleshooting their problem. In either case, a text summary of the graphic(s) may be useful in certain contexts.

In these examples, the customer experiencing an issue can receive through the chat interface, one or more suggestions that (1) summarize steps outlined in comprehensive documentation which can include a textual summary of one or more flowcharts, (2) link to a relevant portion of comprehensive documentation and/or a sub-link to a portion of a graphical element (e.g., a deep link to a portion of a large workflow or process flow diagram), or (3) prompt the customer to provide more information.

In the second case, a service agent can be assisted by automatically generated content that (1) summarizes steps outlined in comprehensive documentation and/or in graphical objects within the comprehensive documentation and/or one or more internal documentation tools or platforms, (2) link to relevant portions of comprehensive documentation, which may include deep linking to a portion of a flowchart or other diagram, or (3) prompt the service agent to request more information from the customer. In some cases, generated content can include questions that may help to further characterize the customer's problem.

The foregoing example contemplates a generative output engine configured to receive content including graphical elements as input and to provide text as output, but it may be appreciated that this is merely one example. For example, in other cases, a generative output engine can be configured to provide graphical output as well. For example, a service agent and/or a generative output engine may identify that a particular large flowchart includes information or steps that may help a user diagnose or solve a problem. In this example, a system as described herein can be configured to reduce the file describing the flowchart, analyze the reduced file format for sections relevant to the user's problem, and provide as output a more concise flowchart that only includes the operations required to be followed by the user to solve the user's problem.

More generally, automatically generated content can assist either or both service agents and customers in ITSM environments, and such systems can be configured to receive graphical objects and input and/or to provide graphical objects as output.

The foregoing embodiments are not exhaustive of the manners by which automatically generated content can be used in multi-platform computing environments, such as those that include more than one collaboration tool.

More generally and broadly, embodiments described herein include systems configured to automatically generate and/or consume natural language content within environments defined by software platforms. The natural language—which may include one or more graphical elements—content can be directly consumed by users of those software platforms or indirectly consumed by users of those software platforms (e.g., formatting of existing content, causing existing systems to perform particular tasks or sequences of tasks, orchestrate complex requests to aggregate information across multiple documents or platforms, and so on) or can integrate two or more software platforms together (e.g., reformatting or recasting user generated content from one platform into a form or format suitable for input to another platform).

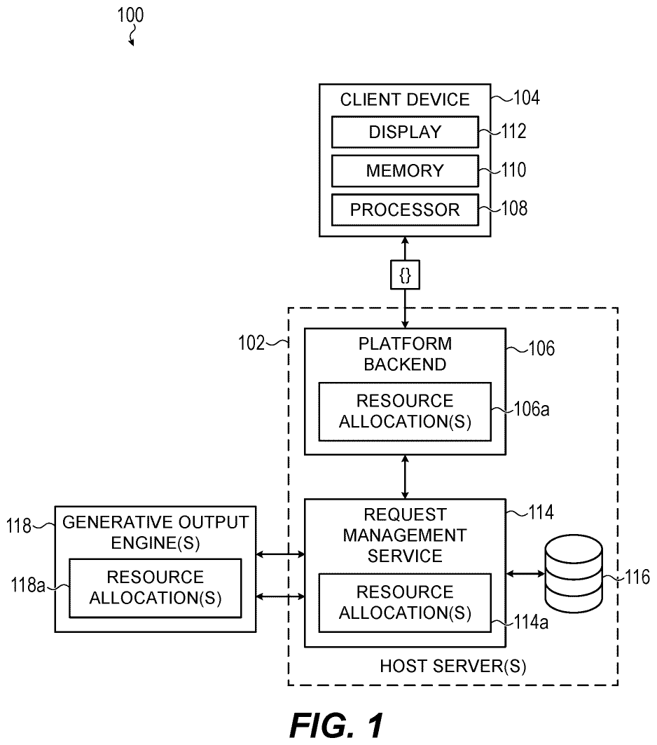

These foregoing and other embodiments are discussed below with reference to FIGS. 1-4. However, those skilled in the art will readily appreciate that the detailed description given herein with respect to these figures is for explanation only and should not be construed as limiting.

FIG. 1 depicts a content collaboration platform 100 and, in particular, a system diagram thereof. The content collaboration platform 100 can be configured to render for a user one or more user interfaces that, in turn, can include one or more user-generated/code-defined graphical elements, which may be referred to as declarative graphical objects.

For example, a declarative graphical object as described herein may be embedded into a page of a documentation platform or may be a member of a set of declarative graphical objects that collectively define a graph, flowchart, object, image, or other visual structure or organization of items shown in a canvas-based free-form input platform. In some cases, a declarative graphical object can be inserted or embedded into a chat window, may be rendered within a notification for a user, rendered as an affordance within a user interface, or the like.

Broadly, the phrase “declarative graphical object” and similar terms may be used to refer to any rendered presentation of visual information that can be defined by instructions or properties stored in a manner that conforms to a structured data format. A declarative graphical object may be static or dynamic, two-dimensional or three-dimensional, and may include elements such as shapes, paths, text, images, animations, or other executable rendering instructions. Similarly the phrase, “structured data” as described herein corresponds to the underlying digital information, code, or instructions that, when executed or parsed, causes a declarative graphical object to be rendered in one or more user interfaces and that may be stored, received, and/or transmitted between computing appliances. In this manner, structured data defines a declarative graphical object as described herein. Structured data may be transmitted, encoded, encrypted, decrypted or otherwise communicated between frontends and backends and between computing appliances. Structured data can be parsed by a rendering engine or other suitable software instance to cause, at a frontend application instance, one or more declarative graphical objects to be rendered.

In this manner, more broadly, structured data representing a declarative graphical object as described herein may include digital information (e.g., an array of numbers, nodes, or coordinates) that defines a drawing path for rendering a particular shape at a particular location within a coordinate space and/or on an end-user's display device. In other cases, structured data representing a declarative graphical object may define a bounding box within which one or more shapes can be drawn or defined. In yet other cases, structured data representing a declarative graphical object can include executable instructions that can be executed by a rendering engine, such as HTML code or CSS class definitions.

In some cases, a declarative graphical object may when rendered be static, whereas in others a declarative graphical object may be animated either as a sequence of frames or by execution of a set of rendering instructions. In some embodiments, a declarative graphical object may be two dimensional, whereas in other cases, a declarative graphical object may be three dimensional. A declarative graphical object as described herein can be rendered at a particular coordinate of a given canvas-based, unconstrained, free-form input system, such as an unbounded canvas. In other cases, a declarative graphical object can be rendered as a portion of a page of a documentation system (e.g., embedded graphic). In yet other cases, a declarative graphical object can be rendered as a user interface element to present dynamic information, such as a table, chart, device network, or the like.

In some cases, declarative graphical objects can also serve as portion of a graphical user interface, such as by defining an affordance of a user interface rendered by a frontend application instance. A declarative graphical object may be or may include, without limitation: a line; an enclosed shape; an open shape; a free form shape; a Bezier curve; a fill pattern; a line of varying width; a continuous curve; a polygonal line segment; a circle; a semicircle; an arc; text; vectorized or path-defined handwriting; vectorized or path-defined sketches; image files; video files; audio files; and the like.

Declarative graphical objects may function independently or as components of larger visual structures like graphs, flowcharts, or user interfaces, and may be embedded in other content or interface parts, such as text content.

Turning to FIG. 1, the content collaboration platform 100 depicted can be configured to manage, process, serve, receive and/or otherwise engage with declarative graphical objects in a variety of different collaborative contexts. For example, the content collaboration platform 100 can be configured to provide a software service defined at least in part by cooperation of a frontend application instance and a backend application instance. The backend application instance may be configured to store user generated content (which may be textual content, user generated graphics, user-defined graphics, or any combination thereof), organize user generated content, and/or perform one or more data operations against user generated content. The frontend application instance can be configured to communicably couple with the backend application instance to provide information to and retrieve information from the backend application instance.

In many embodiments, the frontend application instance can be a web browser application configured to load a remote resource hosted by the backend application instance. The frontend can render one or more user forms to collect authentication credentials from a user of the frontend application instance and/or may be configured to present a token or cookie along with an authentication request or a data request to the backend application instance.

In this manner, more simply, the content collaboration platform 100 can be configured as a client-server system in which a client device renders a graphical user interface (herein, the “frontend”) that communicates with the backend to retrieve user generated content—which may include declarative graphical objects—stored by the backend to render in the graphical user interface.

For example, the content collaboration platform 100 may be a documentation system. In these examples, the frontend may request the backend one or more documents by providing a GET or POST request (as nonlimiting examples) over a computing network, the request including an authentication token and at least one content identifier corresponding to the requested resource. These documents can include software-defined embedded graphics and/or diagrams as described here as declarative graphical objects. In some cases, a declarative graphical object embedded into a page of a documentation system can be defined as HTML and CSS code blocks, whereas in other cases, a declarative graphical object can be defined by a custom structured data, formatted as JSON, YAML, XML, or another serializable format.

Continuing the previous example, and in response to the page request from the frontend, the backend can generate a response to serve to the frontend that includes the requested content. More simply, a frontend can request a document by providing a document identifier to the backend via a network request. In response, the backend can confirm authentication and authorization and thereafter retrieve from a database a document or document part that corresponds to the document identifier. After retrieving the asset, the backend can transmit the document or parts thereof back to the frontend. Once received by the frontend, a graphical user interface of the frontend can be modified to display the requested document or a portion thereof.

A documentation system is one example implementation of the content collaboration platform 100. In other cases, the content collaboration platform 100 can be an issue tracking system, an ITSM system, a project management system, a Kanban board system, a telephony system, a chatbot system, a messaging system, a canvas or whiteboarding system, or any other suitable system that can embed or include declarative graphical objects as described herein.

Generally and broadly, the content collaboration platform 100 can be any suitable system configured to receive input from and/or provide output to two or more users via a graphical user interface of a frontend application instance executing on a client device. The client device and applications instantiated thereon are configured to communicate with a backend that stores information to be retrieved and served to client devices.

As noted above, the content collaboration platform 100 can be configured to provide and/or facilitate access to one or more generative output services to assist users thereof with content creation.

The content collaboration platform 100 includes the host servers 102 which can be one or more physical servers co-located or geographically distributed in more than one location. The host servers 102 can include one or more processing resources (e.g., processors) and one or more memory resources that can be shared or allocated to one or more processes, threads, or instances of software. In some cases, resources of the host servers 102 can be leveraged to instantiate one or more virtual machines that in turn can instantiate one or more software services that perform one or more functions of the content collaboration platform 100, including facilitating communications with a client device 104.

In particular, the host servers 102 can define a virtual machine in which a backend application instance can be instantiated to receive requests from and/or to provide responses to the client device 104. For example, the virtual machine can instantiate a backend platform 106. The virtual machine can have dedicated to it one or more processing resources and memory resources of the host servers 102, specifically identified in FIG. 1 as the resource allocations 106a.

The backend platform 106 is configured to communicably couple to a corresponding frontend application instance executing on the client device 104. Specifically, the client device 104 can include a processor 108, a memory 110, and a display 112. The processor 108 and the memory 110 can cooperate to instantiate a frontend application instance configured to communicate with the host servers 102. The frontend application instance can leverage the display 112 to render a graphical user interface that is associated with the content collaboration platform 100. The graphical user interface can include one or more affordances to receive information from and/or provide information to a user of the client device 104, which may include one or more declarative graphical objects.

As noted above, the backend platform 106 can implement any suitable software service. As with other embodiments described herein, the content collaboration platform 100 can be configured to provide a user of the client device 104 with access to one or more generative output engines to aid the user in one or more ways. As one example, the backend platform 106 is implemented as a documentation platform; in this example, a generative output engine may be used to assist the user in creation of written content. In other cases, a generative output engine may be configured to provide a summary of a long form document stored by the documentation system. In yet other cases, a generative output engine can be used to provide custom notifications based on page change events, may be used to summarize a set of changes made to a page over a given time interval, or suggest changes or rephrasing of a page to improve readability or the like.

In many cases, however, as noted above, a page (and/or more broadly any content that may be served by the backend platform 106) can include one or more declarative graphical objects. In many cases and configurations, structured data representing a declarative graphical object may be verbose and/or over-inclusive of attributes and/or possible feature or rendering options.

As a simplified example, a semicircle can be represented in a number of different ways as structured data. In some cases, it may be advantageous or necessary to store and/or represent a semicircle as a set of individual nodes. In JSON, such an object may be stored as:

```
{
  “nodes”: [
    {“x”: −1, “y”: 0},
    {“x”: −0.9, “y”: 0.44},
    {“x”: −0.8, “y”: 0.6},
    {“x”: −0.7, “y”: 0.71},
    {“x”: −0.6, “y”: 0.8},
    {“x”: −0.5, “y”: 0.87},
    {“x”: −0.4, “y”: 0.92},
    {“x”: −0.3, “y”: 0.95},
    {“x”: −0.2, “y”: 0.98},
    {“x”: −0.1, “y”: 0.99},
    {“x”: 0, “y”: 1},
    {“x”: 0.1, “y”: 0.99},
    {“x”: 0.2, “y”: 0.98},
    {“x”: 0.3, “y”: 0.95},
    {“x”: 0.4, “y”: 0.92},
    {“x”: 0.5, “y”: 0.87},
    {“x”: 0.6, “y”: 0.8},
    {“x”: 0.7, “y”: 0.71},
    {“x”: 0.8, “y”: 0.6},
    {“x”: 0.9, “y”: 0.44},
    {“x”: 1, “y”: 0}
  ]
}
```

As may be appreciated by a person of skill in the art, a generative output engine can be useful to describe or parse this structured data. For example, a generative output engine provided with the foregoing JSON object as input along with the prompt “describe a shape plotted by these nodes” may result in an output of “these nodes approximate a semicircle.” However, as also appreciated by a person of skill in the art, the token count associated with parsing this JSON object as string input is significant. In particular, keys, punctuation, numbers, braces, commas and the like may all be separated as individual tokens by the generative output engine.

As noted above, many generative output engines have performance dependent upon a number of input tokens. The smaller the context by token count, the faster the generative output engine may provide a response. To phrase in another nonlimiting manner, the greater the number of tokens, the greater the likelihood of increased latency.

For many structured data formats representing declarative graphical objects as described herein, token count may scale exponentially with object features. As a result, providing a large structured data object (e.g., that may be associated with a large group of declarative graphical objects) as input to a generative output engine may incur unnecessary delay. In some cases, providing a large structured data object as input to a third-party licensed generative output engine may incur significant expense if licensing is based, in any part, on token counts.

In view of the foregoing disadvantages of verbose structured data representations of declarative graphical objects as described herein, the content collaboration platform 100 includes a request management service 114 that may be configured to convert verbose structured data into concise structured data that includes significantly fewer tokenizable features or structure. In some cases, as an example, the request management service 114 can be configured to convert from one structured data format to another structured data format (e.g., conforming to a first format to conforming to a second format) in order to provide the second format as input to a generative output engine as described herein. In these examples, the second format may be selected for conciseness despite the fact that the second format may not be renderable by the same engines as the first format.

For example, the content collaboration platform 100 may be configured to operate as a web service such that the client device 104 renders a web browser, provides an address directing to a backend application instance hosted by the host servers 102. In these examples, declarative graphical objects may be stored by the host servers 102 as browser-renderable structured data. In one example, this may be as a combination of HTML and CSS (the “first” structured data format). In this case, the request management service 114 may be configured to convert the HTML and CSS data into a declarative diagramming language, such as D2Lang. In these examples, the declarative diagramming language may not be natively renderable by the client device 104, but may nevertheless completely describe the same graphical/diagrammatic structure of the first format defined by HTML and CSS. In this example, the request management service 114 is configured to convert the HTML/CSS combination into D2Lang, and to provide the resulting D2Lang as input to a generative output engine. This pre-conversion step may significantly reduce the number of tokens associated with providing a particular diagram as input to a generative output engine (e.g., for summarization, for context as a portion of another document, or the like).

In many embodiments, the request management service 114 may be instantiated over the resource allocations 114a and may be configured to interface with one or more prompt databases, such as the prompt database 116, and one or more generative output engines 118 (which may be instantiated over one or more resources 118a). In this construction, a user input requesting access to a generative feature (e.g., a feature request) can be received at the graphical user interface of the client device 104.

The request can be forwarded by the frontend application instance to the backend platform 106 which, in turn, can cause the request management service 114 to convert graphical content within and/or referenced by underlying context/content (e.g., a page of a documentation platform) from a first format to a second, more concise format. After reduction of at least some declarative graphical objects from a first format to a second format, the request management service 114 may be configured to access the prompt database 116 to retrieve a suitable prompt or prompt template or system prompt with which to service the feature request (e.g., “summarize this page”).

Once a suitable prompt is retrieved, user information and/or other useful context (e.g., regardless of modality; text, image, audio, and so on) can be appended to a request constructed and transmitted to the generative output engines 118. In response, the generative output engines 118 can provide an output that may be returned to the request management service 114 and/or the backend platform 106, either of which may post-process or otherwise modify the generative result before providing an output back to the user via the graphical user interface of the client device 104.

The foregoing examples are described in view of a configuration in which the content collaboration platform 100 is configured to operate as a documentation system and to provide generative output services useful to users of a documentation system. Such generative output services may be, without limitation: summarization of document text; summarization of a document section; summarization of a group of documents; creation of a table of contents; creation of meeting notes; translation of a document from one language to another; creating definitions of internal terms or project codes; linking related documents together; finding related documents; formatting documents; finding similar figures; finding similar graphical objects; summarizing a group or cluster of graphical objects; interacting with documents in a chatbot interface; instantiating and/or instructing an agent to perform a task; and many more. Broadly, a generative output service can be configured to provide a number of suitable functions in respect of a documentation platform. Different system prompts and/or prompt templates can be leveraged and/or stored by the prompt database 116 to provide and/or assist with execution of one or more generative output features.

A documentation system is merely one example configuration. For example, when configured as an issue tracking system, the content collaboration platform 100 can facilitate the tracking and management of issues, tasks, helpdesk requests, or bugs within a project or organization. In these examples, project workflows and/or troubleshooting workflows may be graphically represented with one or more declarative graphical objects as described above. In these examples, underlying structured data can be partially or entirely converted to more concise formats prior to providing the same input to the generative output engines 118.

As with the prior example, the frontend application instance on the client device 104 includes a graphical user interface rendered on the display 112, which allows users to interact with the issue tracking system (e.g., to make requests and receive responses to those requests from the backend). Users can report new issues, update existing issues, assign tasks, track progress, and the like. The client device 104, equipped with a processor 108 and memory 110, communicates with the backend platform 106 instantiated and/or executing over resources of the host servers 102.

The host servers 102, comprising one or more physical or virtual servers, allocate resources such as processors and memory (resource allocations 106a) to instantiate the backend platform 106. The backend platform 106 handles data storage, organization and retrieval related to issue tracking. It ensures that user-generated content, such as issue reports and status updates that may be supplemented with user-created graphical content, is stored securely and can be accessed and manipulated as needed.

These foregoing embodiments are depicted in FIG. 1 and the various alternatives thereof and variations thereto are presented, generally, for purposes of explanation, and to facilitate an understanding of various configurations and constructions of a system, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

For example, although many embodiments are described herein in reference to converting from one format to another format for the purpose of efficient generative output engine prompting, in other cases, a file format conversion can be performed to upload a product-specific board content format to another, third-party whiteboarding service.

For example, the request management service 114 can be configured in a number of embodiments to trim or segment structured data prior to conversion. For example, in some embodiments the content collaboration platform 100 may be implemented as a canvas whiteboarding application that may be operated by a user or a team of users to input free-form content in a variety of distinct locations throughout one or more whiteboards. In these examples, structured data representing a whiteboard may be over-inclusive in addition to verbose. For example, a user working in a particular region of the whiteboard may request the generative output engines 118 to summarize that portion of the whiteboard. In this construction the request management service 114 can be configured to segment or cluster the content of the whiteboard and to discard content of the whiteboard that is not relevant to the region currently being viewed by the user. In some cases, segmentation or clustering of declarative graphical objects may be performed automatically, in other cases, may be performed with the assistance of the user. For example, the user may lasso or otherwise draw a cursor around a group of objects that, in turn, the request management service 114 can convert from a first format to a second format before providing, along with a suitable prompt, the second format as input to the generative output engines 118.

Further, it may be appreciated that the request management service 114 may be configured to determine whether a particular object requires conversion to a second more concise format or not. For example, in some cases, a simple object formatted in a first format may be more concise and/or equivalently concise to the object's representation in another format. In these examples, the request management service 114 can determine that conversion between formats is not required in advance of providing input to a generative output engine. In some cases, some graphics may be converted while others may be retained in original format. Many constructions are possible.

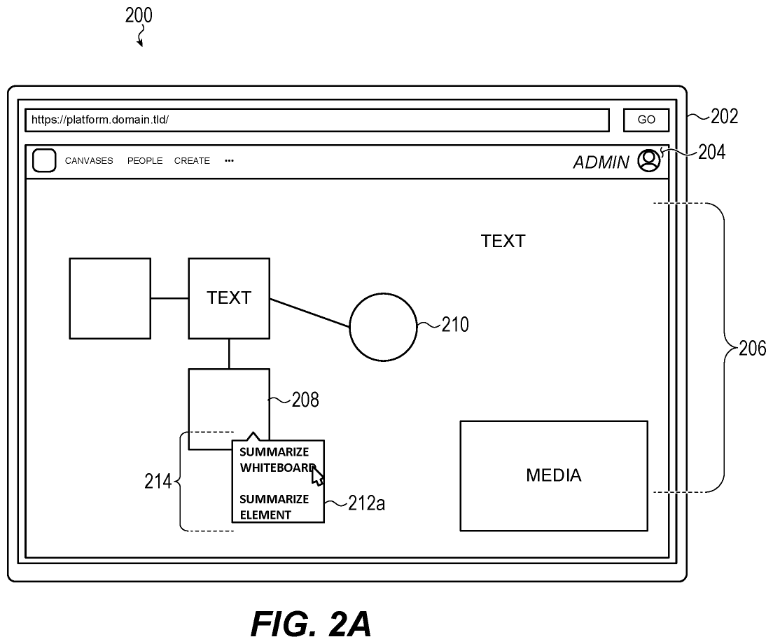

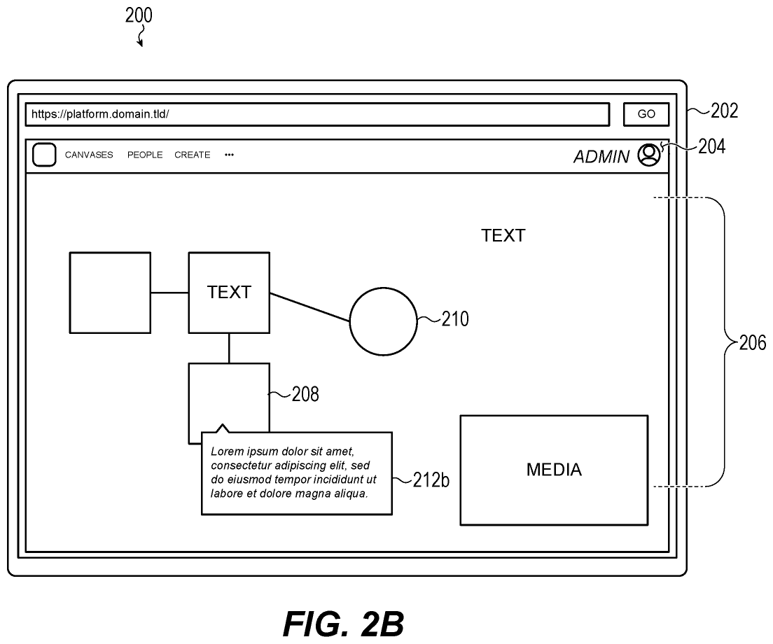

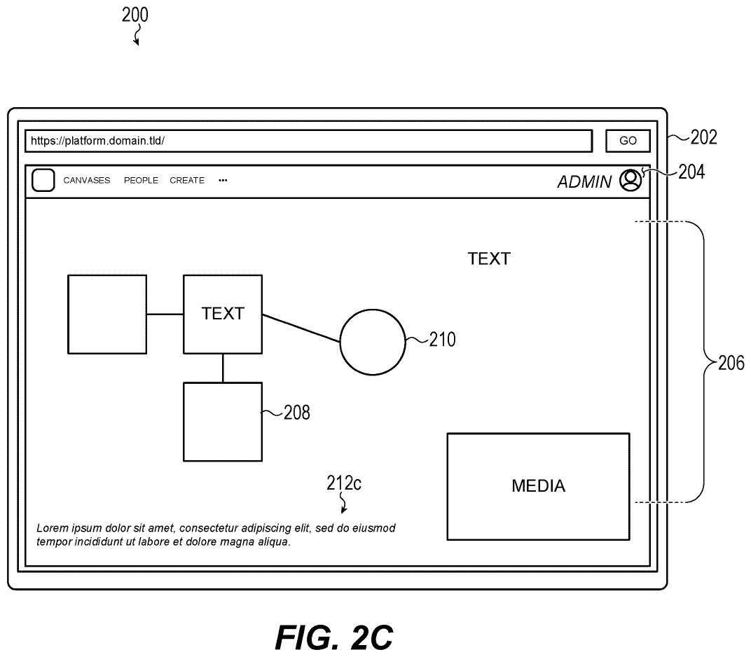

FIGS. 2A-2B depict a client device of a collaboration system as described herein rendering, within a frontend graphical user interface, affordances and modal windows associated with functionality that leverages generative output to engage with free-form graphical user input content items of the collaboration system. FIG. 2C depicts the client device of FIGS. 2A-2B rendering affordances and modal windows associated with functionality that leverages generative output to engage with an arbitrarily large collection of graphical user input content items of the collaboration system.

These illustrated embodiments reference an example use case in which a user requests generative output in respect of existing page content provided as input to a canvas based whiteboarding application. It is appreciated, however that this is merely one method by which a user may request generative output in respect of user generated content.

More specifically, with respect to FIG. 2A, the client device 200 includes a display 202 that can be leveraged by a frontend application instance to render a graphical user interface 204. The graphical user interface 204 can be configured differently for different configurations of a collaboration system as described herein. Specifically, the graphical user interface 204 may be differently implemented for canvas platforms than for issue tracking systems or documentation platforms.

As illustrated, the graphical user interface 204 may be implemented to support a canvas-based whiteboarding application configured to receive graphical user input in a free-form and unconstrained manner. In this example, users can leverage affordances of the graphical user interface 204 to provide text or object input to the canvas platform to create objects, shapes, interconnections therebetween, free line paths, or other graphical objects or parts.

In this construction, the canvas platform can include a user-generated content region 206 into which a user can insert objects to define an arrangement of objects to save as structured data in a data store associated with the canvas platform. As these objects may be stored as structured data, these objects may be declarative graphical objects as described herein. The user-generated content region 206 can include affordances (not shown) to insert shapes, polygons, lines, notes, and/or text areas which may be accompanied by rich text editing features for users to insert text, format text, organize text, and the like.

In many cases, the user-generated content region 206 can include affordances with which a user can interact to request generative output functionality. For example, a user may engage an affordance or execute a keyboard shortcut to request generative output functionality to operate against one or more declarative graphical objects rendered within the user-generated content region 206 by the user. For example, the user may engage with the declarative graphical object 208 or the declarative graphical object 210 to request one or more generative output features or functionality in respect of those objects.

For example, if the user requests a generative output feature by engaging with the declarative graphical object 208, a generative interface panel 212a can be rendered to list several affordances, each associated with a respective one generative output feature (see, e.g., the options 214). The generative output features may include an operation to request a summary of the declarative graphical object 208 be generated. Upon engaging the respective affordance, the user may be presented with a generative result such as shown in the generative interface panel 212b of FIG. 2B, or the generative result 212c of FIG. 2C.

Specifically, as the user engages with the generative interface panel 212a, the structured data representing the declarative graphical object 208 can be transmitted to a backend as described herein, to be received (as one example) by the backend platform 106 of FIG. 1. As noted above, the backend platform 106 can engage with the request management service 114 to reduce the structured data and/or to retrieve an appropriate feature request prompt from the prompt database 116. The prompt(s) retrieved from the prompt database 116 can be populated with the reduced structured data representing the declarative graphical object 208.

In some embodiments, as noted above, a generative output prompt may request information summarizing one element and/or elements/objects to which that element is connected. In this example, structured data associated with the selected element (e.g., the declarative graphical object 208) may be retrieved from a datastore along with structured data representing other elements connected to or spatially proximate to the selected object/element. In these examples, multiple individual elements and their respective connectors or other visual associations (e.g., edges or lead lines between nodes) can be converted/reduced to a second declarative format. In these examples, prompts may request, as one example, to visually summarize a particular cluster of graphical objects or elements. A response generated as a result of the requested generative output in respect of the limited set of elements is shown as the response in the generative interface panel 212b as shown in FIG. 2B.

In other cases, a generative output prompt may request information summarizing or otherwise acting in view of all objects within a canvas. In this example, a response generated as a result of the requested generative output in respect of the complete set of elements associated with a whiteboard is shown as the response in the generative interface panel 212c as shown in FIG. 2C.

These foregoing embodiments are depicted in FIGS. 2A-2C and the various alternatives thereof and variations thereto are presented, generally, for purposes of explanation, and to facilitate an understanding of various configurations and constructions of a user interface, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

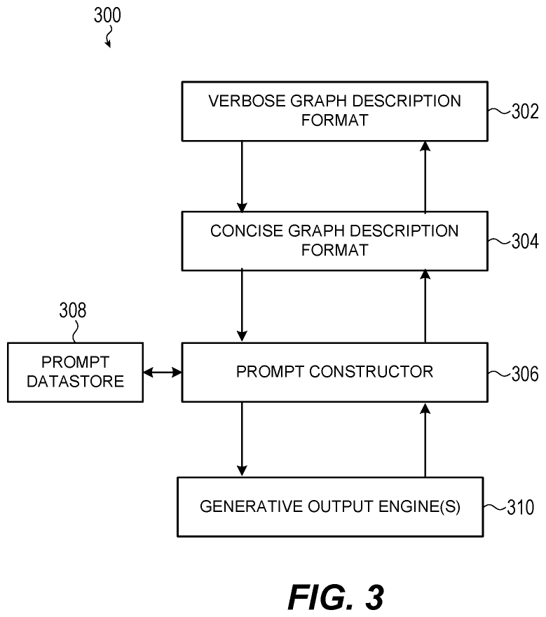

For example, FIG. 3 depicts a system diagram of a content collaboration platform 300 as described herein.

The content collaboration platform 300 includes a content stored in a verbose structured data format 302 that can be rendered within a graphical user interface of a client device executing a frontend application instance, such as described above in respect of FIGS. 1-2D.

The content stored in a verbose structured data format 302 can be associated with user input and/or other user-generated content or other content in response to a user instruction (e.g., such as a user engaging a generative interface panel 212a as described in reference to FIG. 2A).

Once generative output has been requested in respect of the content stored in a verbose structured data format 302, that content can be converted to a concise structured data format 304. In some examples, the concise structured data format 304 may, in some examples, be a declarative diagramming language such as D2Lang, although this is not required of all embodiments.

Once converted to the concise structured data format 304, reduced data may be passed to a prompt constructor 306, which may be configured to access a prompt datastore 308. Thereafter, the prompt constructor 306 can append the reduced data to a suitable prompt (which may be identified by or inferred from the original user input requesting generative output), and provide the hydrated prompt as input to one or more generative output engines 310.

These foregoing embodiments are depicted in FIG. 3 and the various alternatives thereof and variations thereto are presented, generally, for purposes of explanation, and to facilitate an understanding of various configurations and constructions of a system, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

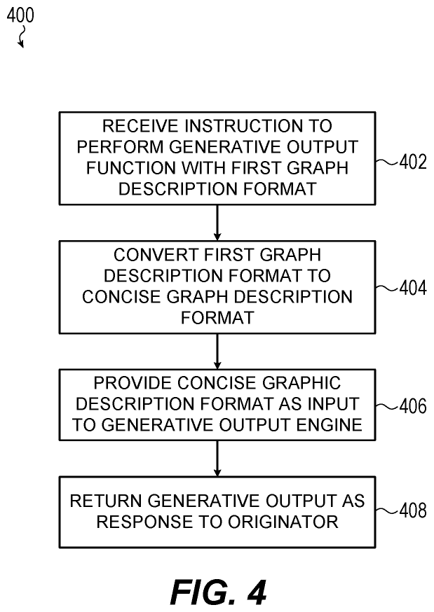

FIG. 4 depicts a flowchart illustrating example operations of a method as described herein. In particular, the method 400 includes operation 402 at which a frontend or backend application instance or other computing appliance or computing resources receives an instruction to perform a generative output function against content that includes a declarative graphical object represented by structured data taking a first graph description format.

The method 400 continues to operation 404 at which a prompt management service or module can operate to convert the first graph description format to a concise graph description format (e.g., D2Lang). In some cases, the conversation operation may modify or reduce verbose serialized graphical objects into a smaller, more efficient structural representations by mapping known elements to known elements, by removing unused attributes or entities, or by passing the first formatted data through a converter.

The method 400 also includes operation 406 at which a prompt management service or module may provide the concise graph description format as input to a generative output engine. The operation 406 may involve transmitting, over one or more computing networks, a populated prompt that includes declarative graphical objects described via the second format as converted by operation 404 to a generative output engine.

The method further includes operation 408 at which a generative output may be received as a response to the originator of the generative output request (see, e.g., operation 402 or the client device 104 of FIG. 1). The operation 408 may cause to be rendered a result or output based on a generative output that is delivered in a manner compatible with a request initially received at the operation 402.

The method 400 may reference one or more data repositories or memory buffers that store first graph description formats or concise graph description formats. The method 400 may also rely on previously configured generative output engines or data transformation modules. The method 400 may not alter the original formatting instructions received during the operation 402 until the operation 404 performs a conversion.

As used herein, the phrase “at least one of” preceding a series of items, with the term “and” or “or” to separate any of the items, modifies the list as a whole, rather than each member of the list. The phrase “at least one of” does not require selection of at least one of each item listed; rather, the phrase allows a meaning that includes at a minimum one of any of the items, and/or at a minimum one of any combination of the items, and/or at a minimum one of each of the items. By way of example, the phrases “at least one of A, B, and C” or “at least one of A, B, or C” each refer to only A, only B, or only C; any combination of A, B, and C; and/or one or more of each of A, B, and C. Similarly, it may be appreciated that an order of elements presented for a conjunctive or disjunctive list provided herein should not be construed as limiting the disclosure to only that order provided.

The foregoing examples and description of instances of purpose-configured software, whether accessible via API as a request-response service, an event-driven service, or whether configured as a self-contained data processing service are understood as not exhaustive. In other words, a person of skill in the art may appreciate that the various functions and operations of a system such as described herein can be implemented in a number of suitable ways, developed leveraging any number of suitable libraries, frameworks, first or third-party APIs, local or remote databases (whether relational, NoSQL, or other architectures, or a combination thereof), programming languages, software design techniques (e.g., procedural, asynchronous, event-driven, and so on or any combination thereof), and so on. The various functions described herein can be implemented in the same manner (as one example, leveraging a common language and/or design), or in different ways.

In many embodiments, functions of a system described herein are implemented as discrete microservices, which may be containerized or executed/instantiated leveraging a discrete virtual machine, that are only responsive to authenticated API requests from other microservices of the same system. Similarly, each microservice may be configured to provide data output and receive data input across an encrypted data channel. In some cases, each microservice may be configured to store its own data in a dedicated encrypted database; in others, microservices can store encrypted data in a common database; whether such data is stored in tables shared by multiple microservices or whether microservices may leverage independent and separate tables/schemas can vary from embodiment to embodiment. As a result of these described and other equivalent architectures, it may be appreciated that a system such as described herein can be implemented in a number of suitable ways. For simplicity of description, many embodiments that follow are described in reference to an implementation in which discrete functions of the system are implemented as discrete microservices. It is appreciated that this is merely one possible implementation.

It may be further appreciated that a request-response RESTful system implemented in whole or in part over cloud infrastructure is merely one example architecture of a system as described herein. More broadly, a system as described herein can include a frontend and a backend configured to communicably couple and cooperate in order to execute one or more operations or functions as described herein. In particular, a frontend may be an instance of software executing by cooperation of a processor and memory of a client device. Similarly, a backend may be an instance of software and/or a collection of instantiated software services (e.g., microservices) each executing by cooperation of a processor resource and memory resources allocated to each respective software service or software instance. Backend software instances can be configured to expose one or more endpoints that frontend software instances can be configured to leverage to exchange structured data with the backend instances. The backend instances can be instantiated over first-party or third-party infrastructure which can include one or more physical processors and physical memory devices. The physical resources can cooperate to abstract one or more virtual processing and/or memory resources that in turn can be used to instantiate the backend instances.

The backend and the frontend software instances can communicate over any suitable communication protocol or set of protocols to exchange structured data. The frontend can, in some cases, include a graphical user interface rendered on a display of a client device, such as a laptop computer, desktop computer, or personal phone. In some cases, the frontend may be a browser application and the graphical user interface may be rendered by a browser engine thereof in response to receiving HTML served from the backend instance or a microservice thereof.

As described herein, the term “processor” refers to any software and/or hardware-implemented data processing device or circuit physically and/or structurally configured to instantiate one or more classes or objects that are purpose-configured to perform specific transformations of data including operations represented as code and/or instructions included in a program that can be stored within, and accessed from, a memory. This term is meant to encompass a single processor or processing unit, multiple processors, multiple processing units, analog or digital circuits, or other suitably configured computing element or combination of elements.

As described herein, the term “memory” refers to any software and/or hardware-implemented data storage device or circuit physically and/or structurally configured to store data in a non-transitory or otherwise nonvolatile, durable manner. This term is meant to encompass memory devices, memory device arrays (e.g., redundant arrays and/or distributed storage systems), electronic memory, magnetic memory, optical memory, and so on.

One may appreciate that although many embodiments are disclosed above, that the operations and steps presented with respect to methods and techniques described herein are meant as exemplary and accordingly are not exhaustive. One may further appreciate that alternate step order or fewer or additional operations may be required or desired for particular embodiments.

Although the disclosure above is described in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the embodiments of the invention, whether or not such embodiments are described and whether or not such features are presented as being a part of a described embodiment. Thus, the breadth and scope of the present invention should not be limited by any of the above-described exemplary embodiments but is instead defined by the claims herein presented.

In addition, it is understood that organizations and/or entities responsible for the access, aggregation, validation, analysis, disclosure, transfer, storage, or other use of private data such as described herein will preferably comply with published and industry-established privacy, data, and network security policies and practices. For example, it is understood that data and/or information obtained from remote or local data sources, only on informed consent of the subject of that data and/or information, should be accessed and/or aggregated only for legitimate, agreed-upon, and reasonable uses.

What is claimed is:

1. A computer-implemented method of providing a declarative graphical object stored by a collaboration system as input to a generative output engine, the method comprising:
receiving, at one or more processors of a host server of the collaboration system, an instruction to perform a generative output function with respect to collaboration system content that comprises at least one declarative graphical object, the at least one declarative graphical object defined by first structured data conforming to a first structured data format;
converting, by the one or more processors, the first structured data into second structured data, the second structured data conforming to a second structured data format more concise than the first structured data format;
retrieving a prompt from a prompt datastore based on the generative output function;
providing at least a portion of the collaboration system content, the second structured data format, and the prompt as input to the generative output engine;
receiving, from the generative output engine and by the one or more processors, an output responsive to the prompt; and
causing a graphical user interface associated with the collaboration system to update in accordance with the output.

2. The method of claim 1, wherein the declarative graphical object is a member of a set of declarative graphical objects; and
the collaboration system content comprises the set of declarative graphical objects; and
each declarative graphical object of the set of declarative graphical objects is converted from the first structured data format into respective second structured data prior.

3. The method of claim 1, wherein the instruction is a user instruction provided to a client device communicably coupled with the collaboration system.

4. The method of claim 3, wherein the client device renders the graphical user interface.

5. The method of claim 1, wherein:
the collaboration system is one of: a whiteboarding application, a documentation platform, an issue tracking system, or an information technology service management platform; and
the content comprises text.

6. The method of claim 1, wherein updating the graphical user interface comprises displaying at least a portion of the output as text in the graphical user interface.

7. The method of claim 1, wherein the prompt causes the generative output engine to at least partially summarize the declarative graphical object.

8. The method of claim 1, wherein the one or more processors are configured to determine whether to convert the first structured data to the second structured data format.

9. A computer-implemented method of providing a declarative graphical object stored by a collaboration system as input to a generative output engine, the method comprising:
receiving a request to render collaboration system content from a graphical user interface of a client device;
requesting the collaboration system content from a collaboration system backend by the client device;
receiving a response from the collaboration system backend, the response comprising the collaboration system content;
updating the graphical user interface to include the received collaboration system content;
receiving a selection by a user of at least one declarative graphical object rendered in the graphical user interface;
receiving an instruction from the user to perform a generative output function with respect to the selected at least one declarative graphical object, the at least one declarative graphical object defined by first structured data conforming to a first structured data format;
in response to the instruction, cause the first structured data to be converted into second structured data and to be provided as input to the generative output engine;
receiving, from the generative output engine, an output responsive to the prompt and the reduced data; and
updating the graphical user interface in accordance with the received output.

10. The method of claim 9, wherein updating the graphical user interface comprises displaying at least a portion of the output in the graphical user interface.

11. The method of claim 9, wherein the instruction causes the output to summarize the selected at least one declarative graphical object.

12. The method of claim 9, wherein converting the first structured data into second structured data comprises removing redundant attributes and unused parameters from the first structured data.

13. The method of claim 9, wherein the second structured data format is a declarative diagramming language format.

14. The method of claim 9, wherein updating the graphical user interface in accordance with the received output comprises rendering a textual summary generated by the generative output engine.

15. A method of reducing content provided as input to a generative output system, the method comprising:
receiving content and a request to perform a generative output function;
determining that the content comprises a declarative graphical object defined by first structured data conforming to a first structured data format;
converting the first structured data into second structured data, the second structured data conforming to a second structured data format different from the first structured data format and resulting in fewer tokens than the first structured data format;
providing at least a portion of the content and the second structured data as input to a generative output system;
receiving, from the generative output engine, an output; and
causing a graphical user interface to update in accordance with the output.

16. The method of claim 15, wherein the second structured data is a declarative diagramming language.

17. The method of claim 15, comprising removing unused attributes from the first structured data prior to converting to the second structured data.

18. The method of claim 15, wherein the content is user-generated content provided as input to a collaboration system.

19. The method of claim 18, wherein the collaboration system is a whiteboarding application.

20. The method of claim 15, wherein providing at least a portion of the content and the second structured data as input to the generative output system comprises appending the at least a portion of the content and the second structured data to a prompt.
